(19) United States
(12) Patent Application Publication
(10) Pub. No.: US 2020/0306586 A1
(43) Pub. Date: Oct. 1, 2020

(54) Golf Green Camera System

(71) Applicant: David Cheung, N.T. Hong Kong (CN)

(72) Inventor: David Cheung, N.T. Hong Kong (CN)

(21) Appl. No.: 16/371,843

(22) Filed: Apr. 1, 2019

(51) Int. Cl. A63B 24/00; A63B 57/40; A63B 57/30; H04N 5/225; H04N 5/232; H04N 7/18

(52) U.S. Cl. CPC A63B 24/0062; A63B 57/40; A63B 57/357; H04N 5/2253; A63B 2102/32; H04N 7/183; A63B 2220/806; A63B 2220/807; A63B 2220/833; H04N 5/23238

(57) ABSTRACT

In some embodiments, the present invention is directed to a golf green camera system comprising a pole having a first end and an opposite second end, a ferrule on the first end of the pole and configured to be inserted into a golf cup and a camera attached to the opposite second end of the pole. The golf cup is configured to be positioned within a corresponding opening in the golf green. The camera records play at the golf green. In some embodiments, the camera comprises a 360-degree camera.

### STATEMENT OF GOVERNMENT INTEREST

Not applicable.

### CROSS REFERENCE TO OTHER PATENT APPLICATIONS

None.

### TECHNICAL FIELD

The present invention generally relates to an accessory for the game of golf.

### BACKGROUND

Golf is one of the most popular sporting events and is played by millions of people all over the world. Playing under par is a challenge for any golfer whether professional or amateur. An even greater challenge is hitting a hole-in one. Many golf games and tournaments are won or lost on the green. Once a player reaches the green, the challenge is to get the ball into the golf cup with the least number of stokes. It is a moment of great joy for any golfer to precisely hit the golf ball into the green golf cup from a significant distance away from the green golf cup. It is desirable to capture such a great moment so the golfer may share such an exciting moment with others at a later time.

What is needed a light-weight portable system for visually recording play at the golf green which is easy to carry, set-up, use and remove.

### SUMMARY

In some embodiments, the present invention is directed to a golf green camera system comprising a pole having a first end and an opposite second end, a ferrule on the first end of the pole and configured to be inserted into a golf cup and a camera attached to the opposite second end of the pole.

In some embodiments, the pole is a one-piece pole.

In some embodiments, the pole comprises a plurality of sections that are attached together.

In some embodiments, the ferrule is removably attached to the first end of the pole.

In some embodiments, the ferrule is integral with the pole.

In some embodiments, the camera is removably attached to the opposite second end.

In some embodiments, the opposite second end of the pole comprises a threaded surface and the camera includes a threaded cavity configured for threaded engagement with the threaded surface.

In some embodiments, the camera comprises a 360-degree camera.

In some embodiments, the golf green camera system further comprises a golf cup having an interior region for receiving a golf ball and a central aperture within the interior region, wherein the ferrule is disposed within the central aperture.

In another aspect, the present invention is directed to a golf green camera system comprising a pole having a ferrule on the first end of the pole. The ferrule is configured to be inserted into a golf cup. The pole includes an opposite second end having at least a portion thereof with threads thereon. The golf green camera system further comprises a camera removably attached to the second opposite end of the pole. The camera includes a threaded cavity configured for threaded engagement with the threads on the portion of the second opposite end of the pole. The golf green camera system further comprises a golf cup having an interior region for receiving a golf ball and an aperture within the interior region. The aperture is sized and configured to receive the ferrule. In one embodiment, the ferrule is rigidly attached to the first end of the pole. In a further embodiment, the ferrule is removably attached to first end of the pole. In yet another embodiment, the ferrule is integral with the first end of the pole. In some embodiments, the camera comprises a 360-degree camera.

Certain features and advantages of the present invention have been generally described in this summary section. However, additional features, advantages and embodiments are presented herein or will be apparent to one of ordinary skill of the art in view of the drawings, specification and claims hereof. Accordingly, it should be understood that the scope of the invention shall not be limited by the particular embodiments disclosed in this summary section.

### BRIEF DESCRIPTION OF THE DRAWINGS

FIG. 1 is a perspective view of a golf green camera system in accordance with an exemplary embodiment of the present invention;

FIG. 2 is a side elevational view of a pole and ferrule of the golf green camera system;

FIG. 3 is a side elevational view showing the pole inserted into the golf cup shown in FIG. 1;

FIG. 4 is a view taken along line 4-4 of FIG. 3;

FIG. 5 is a side elevational view of a pole in accordance with another embodiment of the present invention;

FIG. 6 is a perspective view of a golf green camera system in accordance with another exemplary embodiment of the present invention; and

FIG. 7 is a perspective view of the pole and golf cup shown in FIG. 6.

### DETAILED DESCRIPTION

As used herein, the terms “comprises”, “comprising”, “includes”, “including”, “has”, “having” or any other variation thereof, are intended to cover a non-exclusive inclusion. For example, a process, method, article or apparatus that comprises a list of elements is not necessarily limited to only those elements, but may include other elements not expressly listed or inherent to such process, method, article or apparatus.

It is to be understood that throughout this description, terms such as “vertical”, “horizontal”, “top”, “bottom”, “upper”, “lower”, “middle”, “above”, “below”, “left”, “right” and the like are used for convenience in identifying relative locations of various components and surfaces relative to one another in reference to the drawings and that the system of the present invention may be installed and used in substantially any orientation so that these terms are not intended to be limiting in any way.

Approximating language, as used herein throughout the specification and claims, may be applied to modify any quantitative representation that could permissibly vary without resulting in a change in the basic function to which it is related. Accordingly, a value modified by a term such as “about” or “approximately” is not limited to the precise value specified.

As used herein, the term “camera” shall include cameras configured to capture still images and/or record moving images, single lens sport camera, digital cameras, DSLR cameras, video cameras, camcorders, 360-degree cameras and smart phone cameras.

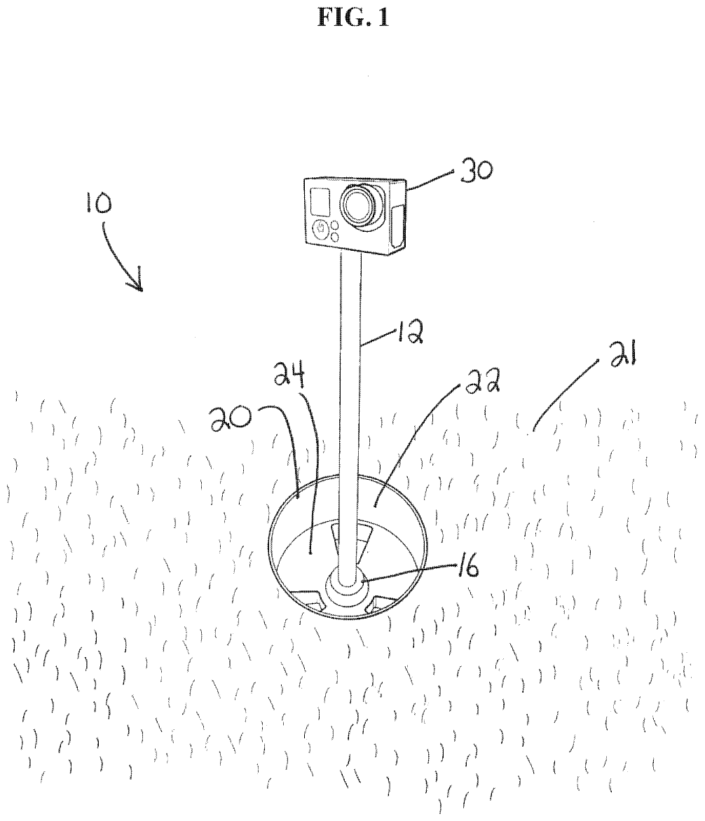

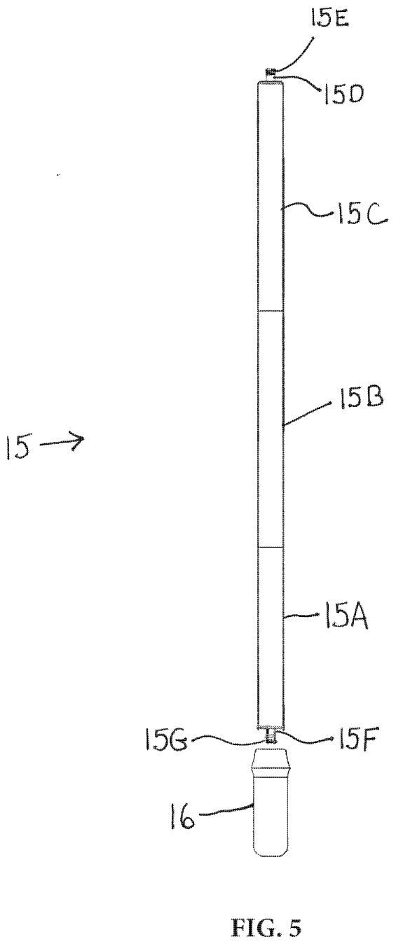

Referring to FIGS. 1-4, there is shown golf green camera system 10 in accordance with an exemplary embodiment of the present invention. Golf green camera system 10 comprises pole 12 which has a first end and an opposite second end 13. Ferrule 16 is on the first end of pole 12 and is discussed in detail in the ensuing description. Opposite second end 13 has a threaded surface 14. The purpose of threaded surface 14 is described in the ensuing description. In an exemplary embodiment, pole 12 is configured as a single-piece or one-piece elongate member. An alternate embodiment of pole 12 is shown in FIG. 5. Alternate pole 15 comprises a plurality of sections 15A, 15B and 15C that are attached together via any suitable attachment technique. For example, in one embodiment, sections 15A, 15B and 15C are configured to be screwed together. In another embodiment, section 15A has an end that is configured to frictionally fit into a corresponding bore or cavity in the end of section 15B. Similarly, section 15B has an end that is configured to be frictionally inserted into a corresponding cavity in the end of section 15C. Section 15C has an end 15D which has threaded surface 15E. Threaded surface 15E has the same function and purpose as threaded surface 14 which is described in the ensuing description. Pole 15 includes end 15F which has threaded surface 15G. Threaded surface 15G engages a threaded cavity (not shown) in ferrule 16. Such a configuration allows ferrule 16 to be screwed onto end 15F of pole 15. In other alternate embodiments, pole 12 has a plurality of telescoping sections. Poles 12 and 15 may be fabricated from any one of a variety of suitable materials, e.g. plastic, PVC, resin, rubber, composites, metal and wood.

Golf green camera system 10 further comprises ferrule 16 which is on the first end of pole 12. In an exemplary embodiment, ferrule 16 is configured to be inserted into golf cup 20. In some embodiments, golf cup 20 is a commercially available golf cup typically used on golf courses. Golf cup 20 comprises a generally cylindrical body that is configured to be inserted or positioned into a corresponding hole or opening in putting green 21 on a golf course. Golf cup 20 has an interior region 22 for receiving a golf ball, a bottom surface 24 within interior region 22 and a central aperture in bottom surface 24. Bottom surface 24 includes openings 25 for drainage. The central aperture is sized to receive ferrule 16. Ferrule 16 has a configuration that allows it to be snug within the central aperture. In an exemplary embodiment, ferrule 16 has a shape and configuration that is the same as the shape and configuration, respectively, of the ferrules that are commonly used on the flag sticks used on golf greens. In an exemplary embodiment, ferrule 16 is removably attached to the first end of pole 12 via any suitable technique. For example, in some embodiments, the first end of pole 12 is threaded and ferrule 16 has a threaded cavity thereby allowing it to be screwed onto the first end of pole 12. Such a configuration is shown in FIG. 5 with respect to the alternate pole 15. In another exemplary embodiment, ferrule 16 is rigidly attached to the first end of pole 12. In a further exemplary embodiment, ferrule 16 is integral with pole 12.

Referring to FIGS. 1, 2 and 4, golf green camera system 10 further comprises camera 30 that is attached to opposite second end 13 of pole 12. Camera 30 includes a threaded cavity (not shown) that is sized and configured for threaded engagement with threaded surface 14 on opposite second end 13 so as to allow camera 30 to be screwed onto second opposite end 13. Such a threaded cavity is found on most commercially available cameras and is typically used to mount the camera on a tripod. However, it is to be understood that camera 30 may be removably attached to opposite second end 13 by any suitable means. In an exemplary embodiment, camera 30 comprises a commercially available 360-degree camera so as to cover 360 degrees about the golf green. Suitable commercially available cameras are sold under the GoPro™, Garmin™ and Sony® trademarks.

In some embodiments, golf green camera system 10 includes golf cup 20. In such embodiments, ferrule 16 is removably attached to golf cup 20. In other embodiments, ferrule 16 is rigidly attached to golf cup 20.

In another exemplary embodiment, golf green camera system 10 includes golf cup 20 but pole 12 does not utilize ferrule 16. In such an embodiment, the first end of pole 12 is rigidly attached to golf cup 20.

In a further exemplary embodiment, golf green camera system 10 includes golf cup 20 which is integral with pole 12. In such an embodiment, ferrule 16 is not used on pole 12.

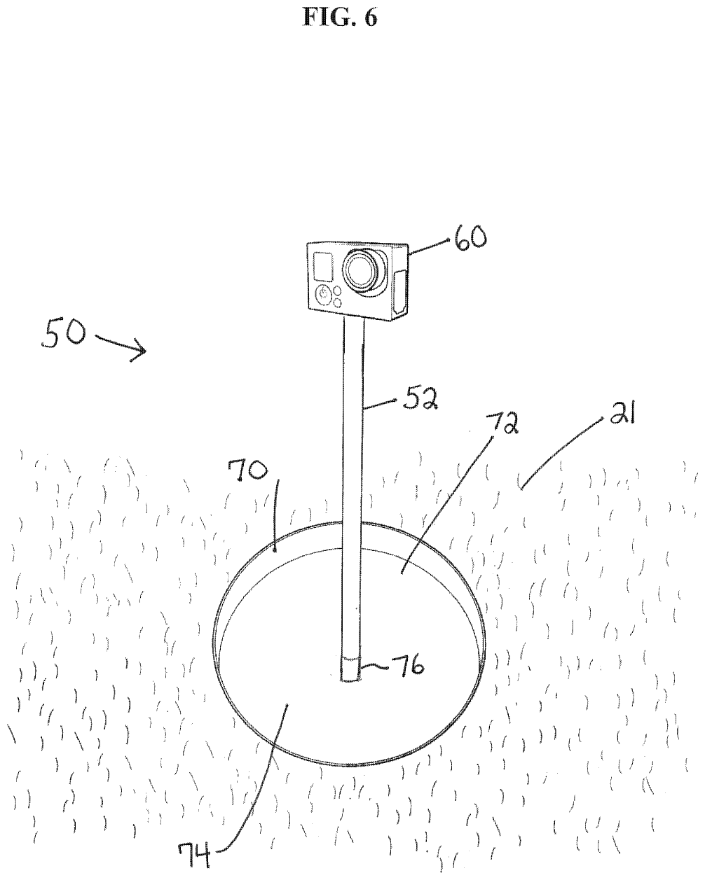

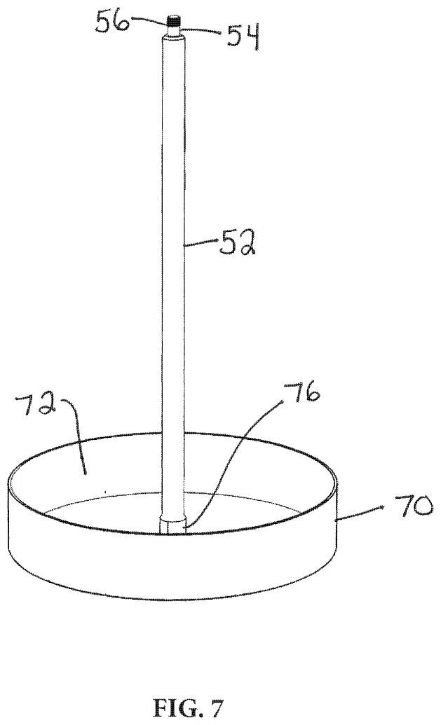

Referring to FIGS. 6 and 7, there is shown golf green camera system 50 in accordance with another embodiment of the present invention. Golf green camera system 50 comprises pole 52 which has a first end and an opposite second end 54. In some embodiments, pole 52 is configured as a single-piece or one-piece elongate member. In an exemplary embodiment, opposite second end 54 of pole 52 has a threaded surface 56 which has the same function and purpose as threaded surface 14 on opposite second end 13 of pole 12. Pole 52 may be fabricated from any one of a variety of suitable materials, e.g. plastic, PVC, resin, composites, metal and wood. In alternate embodiments, pole 52 comprises a plurality of sections that are attached together via any suitable attachment technique as described in the foregoing description with respect to pole 15 (see FIG. 5). In some embodiments, pole 52 has a plurality of telescoping sections.

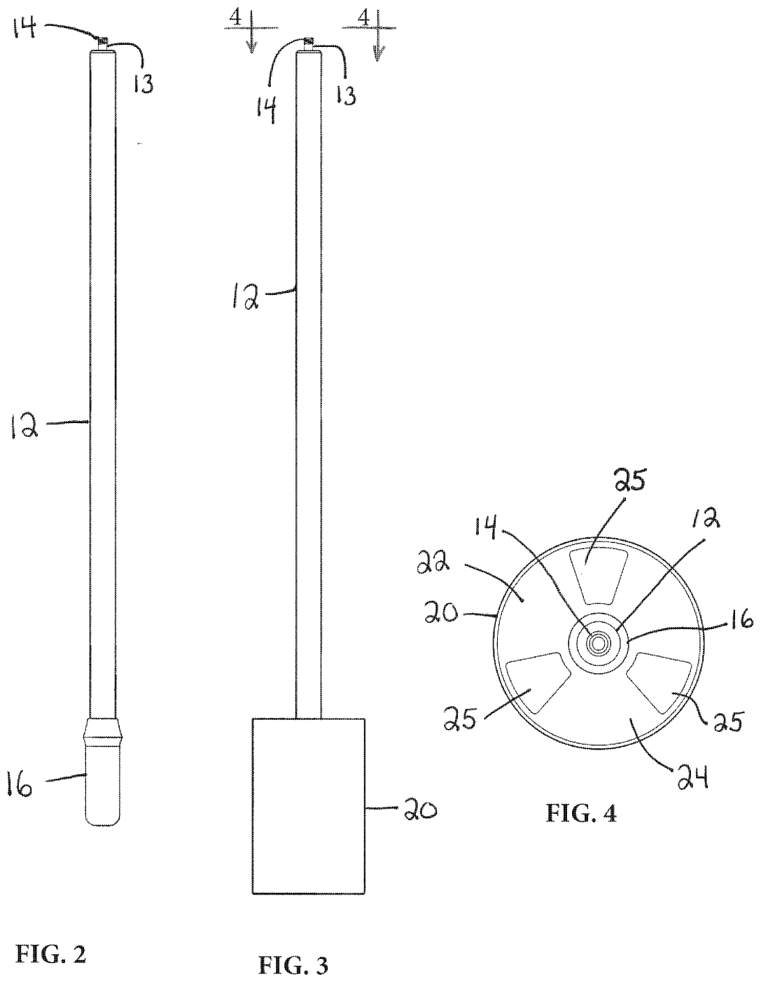

Golf green camera system 50 further comprises camera 60. Camera 60 has the same configuration, function and purpose as that of camera 30 which is described in the foregoing description. Camera 60 includes threaded cavity (not shown) on the underside thereof that is configured for threaded engagement with threaded surface 56. This allows camera 60 to be screwed onto second opposite end 54. Golf green camera system 50 further comprises golf cup 70. The size and shape of golf cup 70 is different than the size and shape, respectively, of golf cup 20 shown in FIG. 2. Golf cup 70 is suitable for practicing putting and may also be inserted into a corresponding opening or hole in the golf green 21. Golf cup 70 has an interior region 72 for receiving golf balls and bottom surface 74 within interior region 72. Golf cup 70 includes upstanding pole support member 76 that is centrally located upon and attached to bottom surface 74. In some embodiments, upstanding pole support member 76 is integral with bottom surface 74. In some embodiments, upstanding pole support member 76 has a bore or cavity and the first end of pole 52 is frictionally inserted into the bore or cavity. In some embodiments, upstanding pole support member 76 has a bore or cavity configured with threads and the first end of pole 52 is threadedly engaged with the threads in the bore or cavity. In some embodiments, the first end of pole 52 is attached to upstanding pole support member 76 via fasteners such as screws or rivets. In some embodiments, golf cup 70 is integral with pole 52.

In some embodiments, a golf pin flag is attached to pole 12 or pole 52 to facilitate indication of the hole to an approaching golfer.

The golf green camera system of the present invention is lightweight, portable and easy to set up, use and remove. The golf green camera system does not interfere with play of the golf game and does not have any negative impact on the environment. The poles, ferrules and golf cups described in the foregoing description may be fabricated from readily available materials including, but not limited to, plastic, resin, PVC, rubber, composites, metal and wood.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1-20. (canceled)

21. A golf green camera system comprising:
a 360-degree camera having a threaded cavity; and
a multi-section pole comprising a plurality of pole sections removably attached together, the plurality of pole sections comprising a top pole section, a bottom pole section and one or more intermediate pole sections between the top pole section and the bottom pole section, the top pole section having an end that comprises a threaded member that is threadedly engaged with the threaded cavity of the 360-degree camera, the bottom pole section having an end that comprises a ferrule that is configured to be inserted into a central aperture of a golf cup.

22. The golf green camera system according to claim 21 wherein the ferrule is integral with the bottom pole section.

23. The golf green camera system according to claim 21 further comprising a golf cup having an interior region for receiving a golf ball and a central aperture within the interior region, wherein the ferrule is disposed within the central aperture.
